(19) United States
(12) Patent Application Publication
(10) Pub. No.: US 2010/0045186 A1
(43) Pub. Date: Feb. 25, 2010

(54) DUAL BRIGHTNESS TWINKLE IN A MINIATURE LIGHT BULB

(76) Inventor: John L. Janning, Bellbrook, OH (US)

Correspondence Address: DICKSTEIN SHAPIRO LLP, 1825 EYE STREET NW, Washington, DC, 20006-5403, US

(21) Appl. No.: 12/611,656

(22) Filed: Nov. 3, 2009

Related U.S. Application Data
(63) Continuation-in-part of application No. 11/687,882, filed on Mar. 19, 2007.
Application No. 11/687,882 is a continuation-in-part of application No. 12/247,975, filed on Oct. 8, 2008.
Application No. 12/247,975 is a continuation-in-part of application No. 12/029,329, filed on Feb. 11, 2008.
Application No. 12/029,329 is a continuation-in-part of application No. 11/542,184, filed on Oct. 4, 2006, now Pat. No. 7,342,327.
(60) Provisional application No. 61/271,539, filed on Jul. 22, 2009.
(60) Provisional application No. 61/273,887, filed on Aug. 10, 2009.
(60) Provisional application No. 61/276,846, filed on Sep. 17, 2009.

(51) Int. Cl. H01J 17/34

(52) U.S. Cl. 315/73

(57) ABSTRACT

A circuit for high-low flashing in a series-wired light string circuit. The series-wired light string includes miniature incandescent bulbs disposed in respective light sockets. A resistive element connected in series with a bi-metallic thermal switching element is mounted—as a shunt—either inside the light socket or inside the bulb, so as to be connected in parallel with the bulb filament. The bi-metallic thermal switching element, in series with the resistive element, electrically switches the resistive element off and on across the bulb filament. The bi-metallic thermal switching electrical contacts are in the normally closed position. Because the resistive element is in parallel with the bulb filament when the bi-metallic switching element is in its normally closed position, the bulb filament brightness is at its low state. As current flows through the resistive element and the bi-metallic thermal switching element, the bi-metallic switching element is warmed and activated and moves from its normally closed position to an open position. The shunt is now removed from across the bulb filament and the bulb illuminates brighter. Since the resistive element no longer passes current through it when it opens, it cools. When it cools sufficiently, the bi-metallic switching element moves back to its normally closed position. The cycle is repeated.

### CROSS-REFERENCE TO RELATED APPLICATIONS

This application claims the benefit of Provisional No. 61/271,539, filed Jul. 23, 2009, Provisional Application No. 61/273,887, filed Aug. 10, 2009, and Provisional Application No. 61/276,846, filed Sep. 17, 2009.

This application is a continuation-in-part of application Ser. No. 12/247,975, filed Oct. 8, 2008, which is a continuation-in-part of application Ser. No. 12/029,329, filed Feb. 11, 2008, which is a continuation-in-part of application Ser. No. 11/542,184, filed Oct. 4, 2006, now U.S. Pat. No. 7,342,327, all of which are incorporated herein by reference.

### BACKGROUND OF THE INVENTION

One of the most common uses of light strings is for decoration and display purposes, particularly during Christmas and other holidays, and more particularly for the decoration of Christmas trees, and the like. Probably the most popular light set currently available on the market, and in widespread use, comprises one or more strings of fifty miniature light bulbs each, with each bulb typically having an operating voltage rating of 2.5 volts, and whose filaments are connected in an electrical series circuit arrangement.

Often, in holiday lighting, flasher bulbs are incorporated in the series-wired string of lights in order for the entire light string to go off and on. Recently, Christmas light strings have become available with miniature light bulbs that flash off and on individually without the entire light string flashing off and on. The parent patents of the present application, upon which priority is claimed, teach such a circuit, which is shown in FIG. 1. A microchip or other voltage responsive shunt 22-31 in the sockets of the flasher bulbs 12-21 continues the current through the series-wired light string when the flasher bulb in the socket goes off and the circuit opens. The off-on action of the flasher bulbs 12-21 is controlled by a bi-metallic switching element inside the bulb. Initially, current flows through the bi-metallic element en route to the bulb filament. In doing so, it warms and pulls away from a contact that connects it to the bulb filament, thus opening the circuit and extinguishing the bulb. Upon cooling, the bi-metallic switching element resumes contact and the bulb lights again. The cycle is repeated.

Random twinkling of Christmas lights is a desirable feature in decorative lighting, including the series-wired light strings with flashers described above. However, it would be desirable to provide random twinkling at various levels of illumination—i.e., high-low twinkling in a series-wired light string.

U.S. Pat. No. 2,235,360 to Davis, Jr. teaches a flasher lamp with dual series connected filaments, and with a thermal element permanently connected at one side to a lead to a first one of the filaments. As the thermal element is heated by the first filament, it moves into contact with a dummy lead wire connected to a point between the two filaments, thereby shorting out the first filament, and diminishing the light output by the bulb. As the first filament cools, the thermal element cools, whereby it moves back out of contact with the dummy lead wire, thereby allowing current to pass again through the first filament, and increasing the light output from the bulb. The problem with such a high-low twinkle flasher lamp is that it is normally in the brightest state, and if the thermal element fails, the lamp remains in the highest output state, which is dangerous. The high-low twinkle flasher bulb of Davis, Jr. also relies upon radiant heat from the filament to activate and deactivate the thermal element, rather than providing a thermal element that is more reliably heated directly by current passing through the element.

The present invention overcomes the disadvantages noted above by providing a circuit for dual brightness twinkle in which the bulb is normally in the low brightness state, and which includes a thermal element that is activated by current passing through the thermal element to switch the bulb to a high brightness state.

### SUMMARY OF THE INVENTION

In accordance with the present invention, current passes through a resistive element connected in series with a bi-metallic thermal switching element which is mounted—as a shunt—either inside the light socket or inside a miniature light bulb, so as to be connected in parallel with the miniature light bulb filament. The bi-metallic thermal switching element, in series with the resistive element, electrically switches the resistive element off and on across the bulb filament. The bi-metallic thermal switching electrical contacts are in the normally closed position. Because the resistive element is in parallel with the bulb filament when the bi-metallic switching element is in its normally closed position, the bulb filament brightness is normally in its low state. As current flows through the resistive element and the bi-metallic thermal switching element, the bi-metallic switching element is warmed and activated and moves from its normally closed position to an open position. The shunt is now removed from across the bulb filament and the bulb illuminates brighter. Since the resistive element no longer passes current through it when it opens, it cools. When it cools sufficiently, the bi-metallic switching element moves back to its normally closed position. The cycle is repeated. Thus, the present invention provides dual brightness from a single filament.

In another embodiment of the invention, a Triac or SCR is used in place of the bi-metallic switching element, i.e., a Triac or SCR in series with a resistive element is connected in parallel with the bulb filament and acts as a shunt, switching the resistive element on and off across the bulb filament at a rate of approximately 10 to 20 times a minute as the Triac or SCR switches on and off.

The brightness levels in the dual brightness twinkle bulb of the present invention are determined by the bulb parameters and the resistive shunt. For example, to achieve a “twinkle-bright” type of operation, where the bulb would get brighter than the other bulbs in the light string, a bulb with a higher voltage rating—but the same current rating—is used for the dual brightness bulb. Such a bulb would dissipate more power and give off more light in the unshunted state. The low end brightness is controlled by the resistive element used to shunt the main filament. The lower the resistance, the lower the bulb brightness will be in the dual brightness operation.

Advantageously, since the high-low light bulb of the present invention is normally in the minimum brightness state and as the bi-metallic switching element is activated, the brightness increases to its maximum state. Thus, if a bulb fails to flash, it is not a problem, as the bulb remains in the safe, low brightness state.

Other features and advantages of the present invention will become apparent when the following description is read in conjunction with the accompanying drawings.

### BRIEF DESCRIPTION OF THE DRAWINGS

FIG. 1 is an electrical schematic diagram of a series-wired light string employing a conventional flasher bulb;

FIG. 2 is electrical schematic diagram of a first embodiment of the present invention with a resistive element connected in series with a bi-metallic thermal switching element—as a shunt—mounted inside the light socket, connected in parallel with the miniature light bulb filament disposed in the socket;

FIG. 3 shows a second embodiment of the present invention with a resistive element connected in series with a bi-metallic thermal switching element—as a shunt—mounted inside the miniature light bulb, connected in parallel with the miniature light bulb filament.

FIG. 4 is electrical schematic diagram of a third embodiment of the present invention with a resistive element connected in series with a Triac or SCR—as a shunt—mounted inside the light socket, connected in parallel with the miniature light bulb filament disposed in the socket

FIG. 5 shows a fourth embodiment of the present invention with a resistive element connected in series with a Triac or SCR—as a shunt—mounted inside the miniature light bulb.

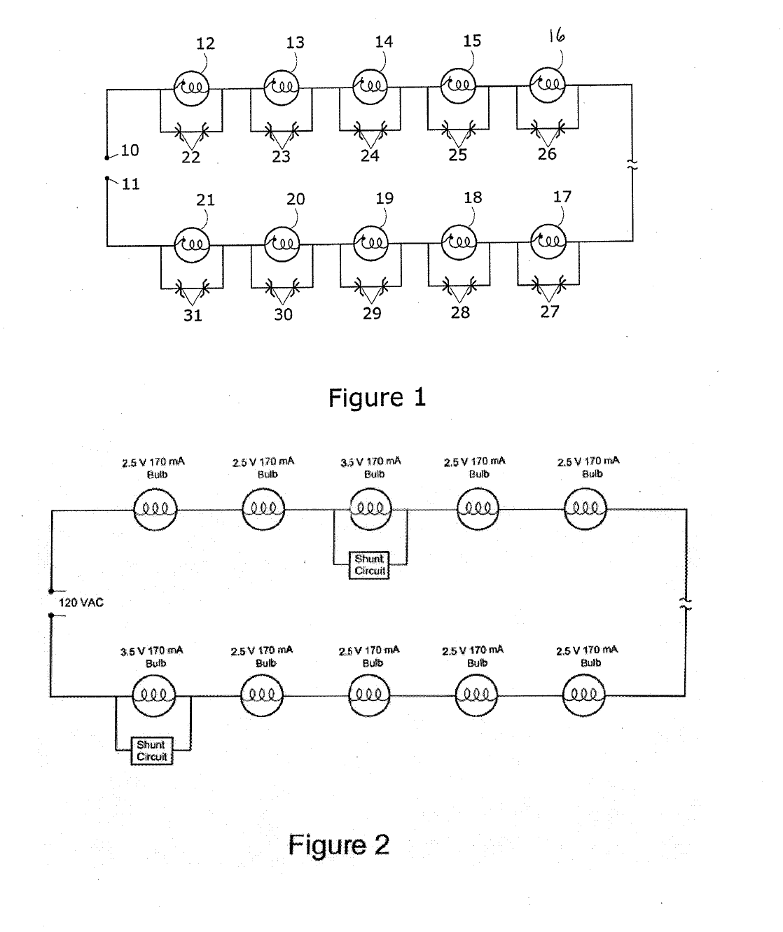

### DESCRIPTION OF THE PREFERRED EMBODIMENT

The random high-low twinkling of the present invention is provided by using bulbs of different voltage ratings. FIG. 2 shows a series-wired Christmas light string containing mostly 2.5 volt 170 mA bulbs. In selected sockets having a thermal shunt connected thereacross, consisting of a resistive element R and a thermal switch TS, the bulbs are of a higher voltage rating. In this case, they are shown to be 3.5 volt 170 mA bulbs. The voltage rating of the bulb is selected for the high brightness point of the dual brightness light bulb in the string. The current rating of the bulb should be the same as the other bulbs in the string. The resistive element R can be a resistor or it can be part of the thermal switch TS. A resistance value for the resistive element shunt across a bulb in a light string having multiple 2.5 volt mini-lights wired in electrical series, and operating at 120 volts AC and 170 mA, would be between 50 and 100 ohms, with a typical value of 65 ohms. This value might be chosen to set the low end brightness of the dual brightness operation to that of the other bulbs in the string. In this manner, one sees the bulbs at normal brightness, and then, selected bulbs get brighter for a short duration—for example, a few seconds—and then back again. This cycle is repeated. The observer sees a random “twinkle-bright” light string with selected lights changing in illumination.

The brightness levels in this dual brightness twinkle bulb circuit are determined by the bulb parameters and the resistive shunt. For example, to achieve a “twinkle-bright” type of operation, where the bulb would get brighter than the other bulbs in the light string, a bulb with a higher voltage rating—but the same current rating—is used for the dual brightness effect. If 2.5 volt 170 mA bulbs are used in the light string, the designated dual brightness bulb might be rated at 3.5 volts and 170 mA. Such a bulb would dissipate more power and give off more light in the unshorted state. The low end brightness is controlled by the resistive element used to shunt the bulb filament. The lower the resistance, the lower the bulb brightness will be in the dual brightness operation. In the preferred embodiment, the brightness is set in the low illumination state to that of the other bulbs in the light string. This is easily done by selecting the proper resistance value for the resistive element R.

While the example given is for 170 mA mini-light bulbs rated at 2.5 volts, other voltage bulbs with other current rating values could be used as well. The preferred thermal switching element TS is that of the reed type for fast acting performance. The bi-metallic element is selected so that the flashing of the bulb from the low brightness to the high brightness occurs at a rate of not more than 40 times per minute, preferably 10 to 20 times per minute.

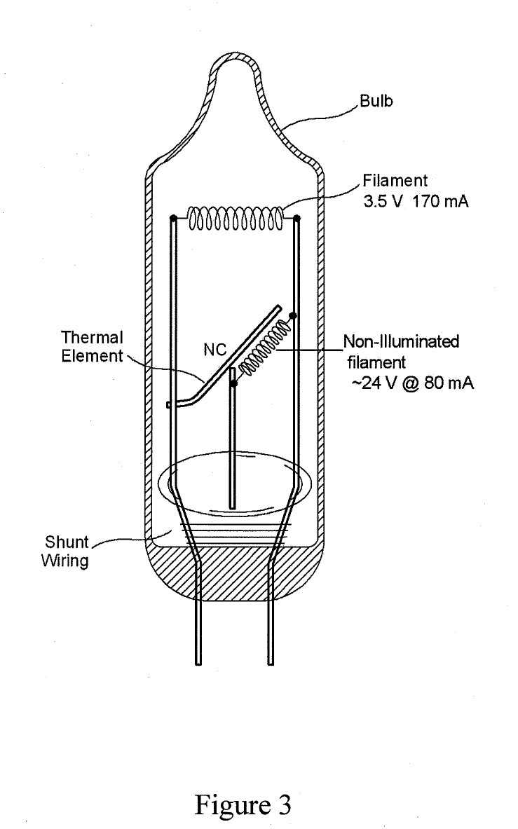

Another embodiment of the invention with bulbs of different voltage ratings is shown in FIG. 3. The main filament in this preferred embodiment of the twinkle bulb is again rated higher (3.5 volt, 170 mA) than the other mini-lights (2.5 volt, 170 mA) in the series-wired light string, but in this embodiment, the twinkle bulb has a bypass non-illuminated filament in the bulb connected in parallel with the main filament to partially shunt the main filament such that its brightness is normally comparable with the other (2.5 volt) bulbs in the light string. As shown in FIG. 3, the bi-metallic element is positioned in close proximity to the non-illuminated filament as well as from the current passing through the bi-metallic element. As current flows through the bi-metallic element and the non-illuminated element, the bi-metallic element (switch) moves from its normally closed position to an open position due to warming. Thus, the non-illuminated filament shunt is removed from being across the main filament and the main filament glows brighter. As the bi-metallic element cools, it goes back to its normally closed position again which connects the non-illuminated filament across the main filament again, reducing its brightness to that of the other bulbs in the light string. The bi-metallic element is selected so that the flashing of the bulb from the low brightness to the high brightness occurs at a rate of not more than 40 times per minute, preferably 10 to 20 times per minute.

The non-illuminated filament does not illuminate because it has a voltage rating that is much higher that the voltage that would appear across the main filament. In this preferred embodiment, a 24 volt filament rated at 80 mA is used as the shunt.

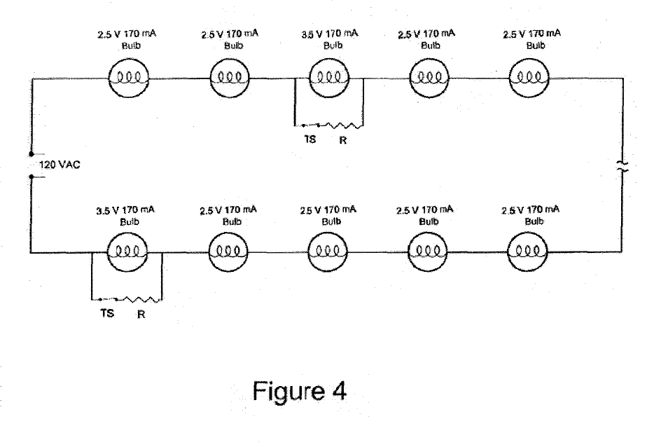

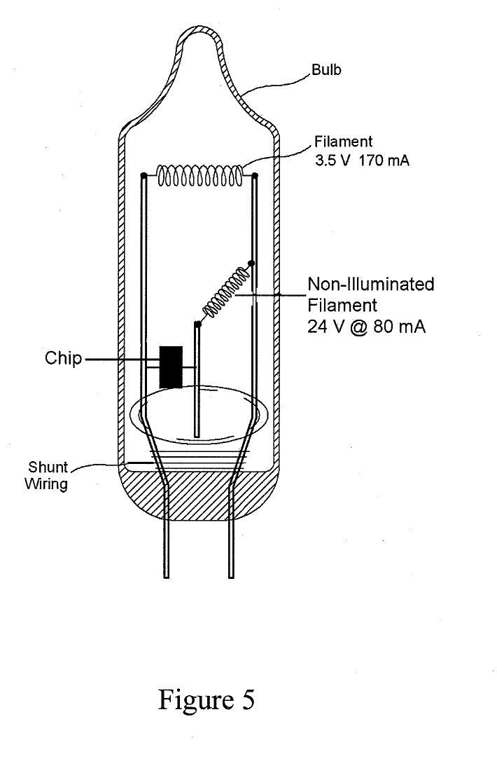

In still further embodiments of the invention with bulbs of different voltage ratings, shown in FIGS. 4 and 5, current passes through a Triac or SCR shunt circuit connected in parallel with the bulb filament, either in the socket (FIG. 4) or in the bulb (FIG. 5). In another words, in these embodiments of the invention, a Triac or SCR is used in place of the bi-metallic switching element of the prior embodiments. A Triac or SCR in series with a resistive element is thus connected in parallel with the bulb filament and acts as a shunt, switching the resistive element on and off across the bulb filament at a rate of approximately 10 to 20 times a minute as the Triac or SCR switches on and off. Because the resistive element is essentially in parallel with the bulb filament, when the Triac or SCR fires, the bulb filament brightness is lowered. When the capacitor in the Triac or SCR shunt circuit expends it energy and the Triac or SCR switches off, the bulb filament brightens as the resistive shunt is removed from across the filament. The cycle is repeated. This dual brightness from a single filament is novel, as in the other embodiments of the invention.

As in the prior embodiments, the brightness levels in the Triac or SCR embodiment are determined by the bulb parameters and the resistive shunt. Again, the dual brightness bulb might be rated at 3.5 volts and 170 mA whereas the other bulbs of the string might be rated at 2.5 volts and 170 mA. The dual brightness bulb would dissipate more power and give off more light in the unshunted state. The low end brightness is controlled by the resistive element used to shunt the main filament. The lower this resistance, the lower the bulb brightness will be in the dual brightness operation.

A resistance value for the shunt resistive element for a 3.5 volt 170 mA mini-light bulb operating in a light string having 49 other 2.5 volt mini-lights wired in electrical series and operating at 170 mA would be between 60 and 130 ohms, with a typical value of 110 ohms.

FIG. 4 shows a typical series-wired light string with two dual brightness bulb assemblies and their associated shunt circuits connected thereacross.

FIG. 5 shows the Triac or SCR circuit contained primarily on a chip, with the chip inserted inside the bulb at the time of bulb manufacture. The resistive shunt in this case might be a non-illuminated filament or it could just be a resistor contained on the chip. The non-illuminated filament in FIG. 5 is shown as rated at 24 volts at 80 mA. This value might change to a different value depending on the desired brightness at the low level.

Having so described and illustrated the principles of my invention in a preferred embodiment, it is intended, therefore, in the annexed claims, to cover all such changes and modifications as may fall within the scope and spirit of the following claims.

What is claimed is:

1. A series-wired light string, comprising:
a plurality of light bulbs, including at least one bulb having a voltage rating higher than the other bulbs of the series-wired string;
a plurality of light sockets, each light socket of the plurality of light sockets adapted to receive at least one of the plurality of light bulbs; and
a shunt circuit disposed across the filament of the bulb having a higher voltage, the shunt circuit comprising a resistive element and a thermal element that moves alternately between an open position and a closed position as the thermal element heats when current is passing therethrough and cools when current is not passing therethrough,
wherein, when the thermal element is in the closed position with current passing therethrough, the filament of the bulb having a higher voltage is shunted by the resistive element, such that the filament carries less current and produces light of a low brightness, and
wherein, when the thermal element heats up as current passes therethrough and moves to an open position, the filament is no longer shunted by the resistive element and carries full current, whereby the filament produces light of a high brightness,
thereby causing the light bulbs having a higher voltage rating to produce illumination of a high and low brightness at different times to cause the light string to exhibit a twinkling effect.

2. A series-wired light string as recited in claim 1, wherein the shunt circuit is disposed in the socket of the bulb having a higher voltage rating.

3. A series-wired light string as recited in claim 1, wherein the shunt circuit is disposed in the bulb having a higher voltage rating.

4. A series-wired light string as recited in claim 1, wherein the bulbs having a higher voltage rating are further provided with internal shunt wiring extending between the filament leads.

5. A series-wired light string as recited in claim 1, wherein the thermal element comprises a bi-metallic switching element.

6. A series-wired light string as recited in claim 1, wherein the thermal element comprises a triac.

7. A series-wired light string as recited in claim 1, wherein the thermal element comprises an SCR.

8. A method of operating a series-wired light string comprising a plurality of light bulbs including a plurality of light bulbs having a voltage rating higher than the other bulbs of the series-wired light string, a plurality of light sockets, each light socket of the plurality of light sockets adapted to receive at least one of the plurality of light bulbs, and a shunt circuit disposed across the filament of the bulb having a higher voltage, the shunt circuit comprising a resistive element and a thermal element that moves alternately between an open position and a closed position as the thermal element heats when current is passing therethrough and cools when current is not passing therethrough,
wherein, when the thermal element is in the closed position with current passing therethrough, the filament of the bulb having a higher voltage is shunted by the resistive element, such that the filament carries less current and produces light of a low brightness, and
wherein, when the thermal element heats up as current passes therethrough and moves to an open position, the filament is no longer shunted by the resistive element and carries full current, whereby the filament produces light of a high brightness, thereby causing the light bulbs having a higher voltage rating to produce illumination of a high and low brightness at different times to cause the light string to exhibit a twinkling effect.

9. A method of operating a series-wired light string as recited in claim 8, wherein the bulb having a higher voltage rating intermittently flashes to the higher brightness for a period of at least one second before relaxing to its original low illumination state

10. A method of operating a series-wired light string as recited in claim 8, wherein the bulb having a higher voltage rating flashes from the low brightness to the high brightness at a rate of not more than forty times per minute.

11. The series-wired light string of claim 10, wherein the flashing rate is ten to twenty times per minute.

12. A flasher bulb for producing alternately high and low illumination in series-wired light string comprising at least one bulb having a voltage rating higher than the other bulbs of the series-wired string, comprising:
a filament; and
a shunt circuit disposed across the filament, the shunt circuit comprising a resistive element and a thermal element that moves alternately between an open position and a closed position as the thermal element heats when current is passing therethrough and cools when current is not passing therethrough,
wherein, when the thermal element is in the closed position with current passing therethrough, the filament of the bulb is shunted by the resistive element, such that the filament carries less current and produces light of a low brightness, and
wherein, when the thermal element heats up as current passes therethrough and moves to an open position, the filament is no longer shunted by the resistive element and carries full current, whereby the filament produces light of a high brightness.

13. A flasher bulb as recited in claim 12, wherein the bulb is further provided with internal shunt wiring extending between the filament leads.

14. A flasher bulb as recited in claim 12, wherein the thermal element comprises a bi-metallic switching element.

15. A flasher bulb as recited in claim 12, wherein the thermal element comprises a triac.

16. A flasher bulb as recited in claim 12, wherein the thermal element comprises an SCR.

17. A flasher bulb as recited in claim 12, wherein the bulb intermittently flashes to the high brightness state for a period of at least one second before relaxing to its original low brightness state.

18. A flasher bulb as recited in claim 17, wherein the flashing rate is ten to twenty times per minute.
